(19) United States
(12) Patent Application Publication
(10) Pub. No.: US 2025/0053184 A1
(43) Pub. Date: Feb. 13, 2025

(54) VOLTAGE REFERENCE CIRCUIT

(71) Applicant: Wise-Integration, Hyeres (FR)

(72) Inventors: Dominique Bergogne, Saint Didier En Velay (FR); Sebastian Gaviria Duque, Grenoble (FR); Plinio Bau, Saint-Martin-D'heres (FR)

(73) Assignee: Wise-Integration, Hyeres (FR)

(21) Appl. No.: 18/717,749

(22) PCT Filed: Dec. 20, 2022
(86) PCT No.: PCT/FR2022/052440

§ 371 Date: Jun. 7, 2024

(30) Foreign Application Priority Data
Dec. 23, 2021 (FR) 2114322

(51) Int. Cl. G05F 3/24; G05F 3/30

(52) U.S. Cl. CPC G05F 3/242; G05F 3/30

(57) ABSTRACT

The invention relates to a voltage reference circuit comprising: a trailing transistor, the source and the gate of which are connected to the terminals of the dipole, a connecting quadrupole, the first terminal of which is connected to the gate of a leading transistor, the second terminal is connected to the source of the leading transistor, the third terminal to the source of the trailing transistor and the fourth terminal to the drain of the trailing transistor, the reference voltage being supplied to the source of the leading transistor, and a base transistor, the source of which is connected to the ground and the gate of which is connected to its drain, said drain being connected to a terminal of a second dipole, the other terminal of which is connected to the first dipole.

### TECHNICAL FIELD

The invention relates to the field of voltage reference circuits used in integrated circuits. The invention relates, in particular, to a voltage reference circuit having a structure making it possible to limit the energy consumption of the circuit, while providing a constant voltage reference, even when the power source, the temperature or the parameters of the components vary.

### STATE OF THE ART

Conventionally, the voltage reference circuits are circuits which supply a stable and constant reference voltage over time. It is moreover sought to obtain a reference voltage insensitive to the variations of certain parameters.

As an example, these parameters are, for example, the supply voltage, the temperature, the manufacturing dispersions or also the ageing of the components.

In particular, transistors are often found in voltage reference circuits. Yet, the parameters of a given transistor can greatly vary according to the manufacturing process that they undergo. Moreover, two transistors having undergone the same manufacturing process can be broadly different according to the positioning that they have, on the semiconductor plate, having served for their manufacturing.

One of these parameters is the voltage threshold value from which a channel is formed between the drain and the source of a given transistor. This minimum value is that to apply between the gate and the source, in order to conduct an electric current between the drain and the source of said given transistor. This parameter can vary up to 50% from one transistor to another, which can lead to a loss in stability of the voltage reference of the circuit.

A voltage reference circuit generally comprises two types of transistors: depletion-mode transistors and enhancement-mode transistors.

Such as illustrated in FIG. 1 of the prior art, a depletion-mode transistor 2005 is commonly symbolised with a solid line connecting the drain, the source and the base. An enhancement-mode transistor 2025 is commonly symbolised with a dotted line connecting the drain, the source and the base.

As an example, such as illustrated in FIG. 1 extracted from document U.S. Pat. No. 9,647,476 B2, a voltage reference circuit 2000 generally comprises a depletion-mode transistor 2005, the drain of which is connected to a voltage source V+ and the source of which is connected with eight enhancement-mode transistors 2025 in series. Each enhancement-mode transistor 2025 has its gate connected to its drain and the last enhancement-mode transistor of the series has its source connected to the ground. The gate of the depletion-mode transistor 2005 is also connected to the ground. The reference voltage Vref is measured between a point located between a capacitor 2015 and the source of an enhancement-mode transistor 2055, the gate of which is connected between the sixth and the seventh depletion-mode transistor of the series.

In this configuration, the voltage reference circuit 2000 makes it possible to obtain a low current consumption, typically less than 1 μA. However, such a circuit does not make it possible to reach high reference voltage values. Furthermore, this type of mounting is sensitive to the variations in parameters of the transistors. The reference voltage therefore has instabilities.

The technical problem that the invention proposes to resolve is to obtain a stable voltage reference circuit, in particular vis-à-vis variations of methods for manufacturing transistors, while limiting the consumption of the circuit.

### SUMMARY OF THE INVENTION

To resolve this problem, the Applicant has developed a voltage reference circuit comprising:
a so-called “leading” depletion-mode transistor, the drain of which is connected to a voltage source,
a so-called “trailing” depletion-mode transistor, the source of which is connected to a terminal of a first dipole, and the gate of which is connected to the second terminal of the first dipole,
a connecting quadrupole, the first terminal of which is connected to the gate of the leading transistor, the second terminal of which is connected to the source of the leading transistor, the third terminal of which is connected to the source of the trailing transistor, and the fourth terminal of which is connected to the drain of the trailing transistor, the reference voltage being provided at the source of the leading transistor, and
a so-called “base” enhancement-mode transistor, the source of which is connected to the ground and the gate of which is connected to its drain, said drain being connected to a second terminal of a second dipole, the first terminal of which is connected to the second terminal of the first dipole.

Thus, the voltage reference circuit comprises precisely twice as many depletion-mode transistors than enhancement-mode transistors, which makes it possible to compensate for the variations in threshold value defined above. Indeed, for N-channel transistors, depletion-mode transistors have a negative threshold value, while enhancement-mode transistors have a positive threshold value. Furthermore, the absolute value of the threshold value of an enhancement-mode transistor is substantially equal to double the threshold value of a depletion-mode transistor. Thus, an enhancement-mode transistor makes it possible to compensate for a pair of depletion-mode transistors. The threshold values are compensated for, even are cancelled, which makes it possible to limit the deleterious effects on the value of the reference voltage.

Furthermore, such a circuit has very few components compared with the prior art. It is therefore easier to integrate in integrated circuits with reduced dimensions. In addition, less interferences, linked to the interactions of components with one another, appear on the voltage reference signal, due to the limited number of components.

According to a first embodiment, the connecting quadrupole consists of two short-circuits respectively connecting the first and third terminals and the second and fourth terminals.

Advantageously, the second dipole is thus a short-circuit.

This embodiment is the simplest. The circuit only comprises that two depletion-mode transistors, an enhancement-mode transistor and a dipole, that is four components in total. Such a circuit is therefore particularly easy to implement and to integrate in integrated circuits with reduced dimensions.

According to a second embodiment, the connecting quadrupole comprises two depletion-mode transistors: a top transistor and a bottom transistor, the source of the top transistor being connected to the drain of the bottom transistor and to the first terminal of the connecting quadrupole, the drain of the top transistor being connected to the second terminal of the connecting quadrupole, the gate of the bottom transistor being connected to the third terminal of the connecting quadrupole and the gate of the top transistor and the source of the bottom transistor being connected to the fourth terminal of the connecting quadrupole.

Advantageously, the second dipole thus comprises an enhancement-mode transistor, the source of which is connected to the second terminal of the second dipole and the gate of which is connected to its drain, said drain being connected to the first terminal of the second dipole.

In this embodiment, the circuit thus comprises two enhancement-mode transistors, the threshold values of which are compensated for with the two pairs of depletion-mode transistors.

According to a third embodiment, the connecting quadrupole consists of n elementary quadrupoles, with n>1, each elementary quadrupole comprising two depletion-mode transistors, namely a top transistor and a bottom transistor, the source of the top transistor being connected to the drain of the bottom transistor and to a first terminal of the elementary quadrupole, the drain of the top transistor being connected to a second terminal of the elementary quadrupole, the gate of the bottom transistor being connected to a third terminal of the elementary quadrupole and the gate of the top transistor and the source of the bottom transistor being connected to a fourth terminal of the elementary quadrupole. These elementary quadrupoles are connected in series, with two consecutive elementary quadrupoles, connected such that the first terminal of the elementary quadrupole is connected to the third terminal of the elementary quadrupole and the second terminal of the elementary quadrupole is connected to the fourth terminal of the elementary quadrupole. The first and the second terminal of the elementary quadrupole form the first and the second terminal of the connecting quadrupole and the third and the fourth terminal of the elementary quadrupole form the third and the fourth terminal.

Advantageously, the second dipole thus comprises n enhancement-mode transistors, each of said transistors having its gate connected to its drain, said transistors being connected in series, two consecutive transistors being connected by the source of one and the drain of the other and, the drain of the first transistor forming the first terminal of the second dipole and the source of the last transistor forming the second terminal of the second dipole.

The number of enhancement-mode transistors and the number of depletion-mode transistors is chosen according to the voltage reference value that is sought to be obtained. The greater the number of enhancement-mode transistors (and the number of depletion-mode transistors), the more the voltage value at the input of the circuit and the value of the reference voltage can be increased.

According to the embodiments, the first dipole can, for example, be an enhancement-mode transistor, the gate of which is connected to its drain. The transistor is thus comprised like a diode. Preferably, the first dipole is a resistor, which makes it possible to best compensate for the variations within the circuit. The sizing of the transistor or the value of the resistor, in principle, has no significant impact on the value of the voltage reference. However, the sizing of these components can be adapted, in order to limit the energy consumption of the voltage reference circuit.

In practice, depletion-mode and enhancement-mode transistors can be GaN transistors or MOS transistors without changing the invention.

### DESCRIPTION OF THE FIGURES

The manner in which to achieve the invention, as well as the advantages which result from it, will emerge from the description of the embodiments below, in support of the accompanying figures, in which:

FIG. 1 is an electric diagram of a voltage reference circuit of the prior art,

FIG. 2 is an electric diagram of the voltage reference circuit according to a first embodiment of the invention,

FIG. 3 is an electric diagram of the voltage reference circuit according to an alternative embodiment of the first embodiment of FIG. 2,

FIG. 4 is an electric diagram of the voltage reference circuit according to a second embodiment of the invention,

FIG. 5 is an electric diagram of the voltage reference circuit according to a fourth embodiment of the invention,

FIG. 6 is an electric diagram of the voltage reference circuit according to a third embodiment of the invention,

FIG. 7 is a graph comparing the development of the reference voltage according to the temperature for the circuit of the invention and for a circuit of the state of the art, and

FIG. 8 is a graph comparing the development of the reference voltage according to the supply voltage for theoretically identical transistors, but the intrinsic parameters of which differ due to manufacturing tolerances, for the circuit of the invention and for the circuit of the state of the art.

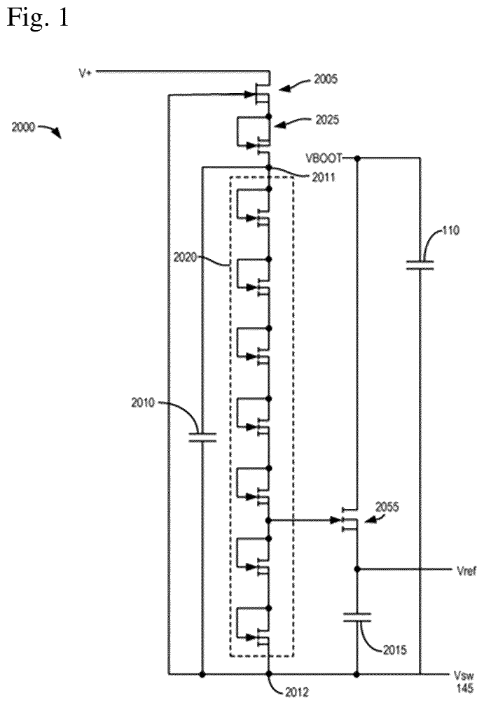

### DETAILED DESCRIPTION OF EMBODIMENTS

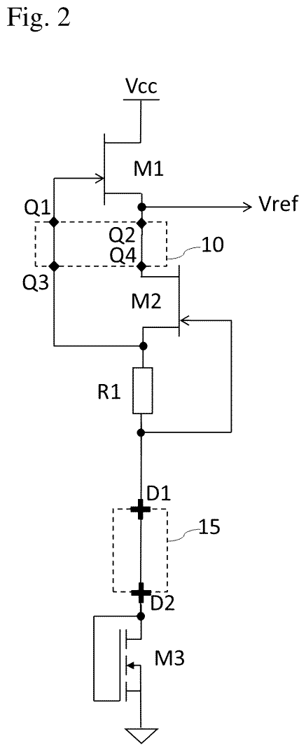

Such as illustrated in FIGS. 2 to 6, the voltage reference circuit of the invention comprises a leading transistor M1, M11, M21, M31, the drain of which is connected to a voltage source Vcc. The voltage source Vcc preferably supplies a direct voltage of between 0 and 12V. However, this direct voltage can have variations around the target voltage. Typically, the voltage can vary from 0.1 to 0.5% with respect to its target value.

The voltage reference circuit of the invention also comprises a trailing transistor M2, M14, M26, M36.

The two leading M1, M11, M21, M31 and trailing M2, M14, M26, M36 transistors are connected to one another by a connecting quadrupole 10, 20, 30, 40.

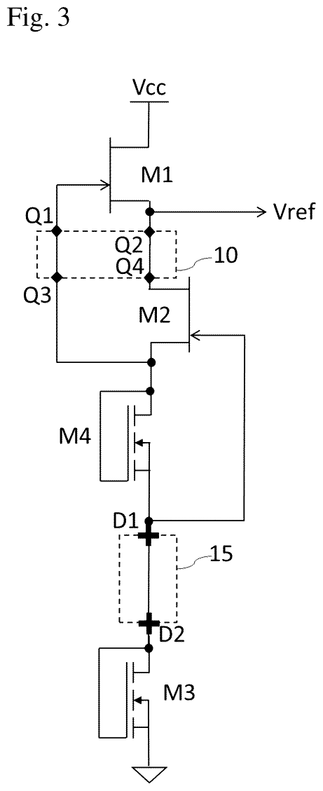

In the embodiment of FIGS. 2 and 3, the connecting quadrupole 10 corresponds to two short-circuits. A first short-circuit connects the terminals Q1 and Q3 of the connecting quadrupole 10 and the second short-circuit connects the terminals Q2 and Q4 of the connecting quadrupole 10.

Thus, the leading transistor M1, M11, M21, M31 is connected, by its source, to the drain of the trailing transistor M2, M14, M26, M36, by way of the short-circuit connecting the terminals Q2 and Q4. In addition, the source of the trailing transistor M2, M14, M26, M36 is connected to the gate of the leading transistor M1, M11, M21, M31 by way of the short-circuit connecting the terminals Q1 and Q3.

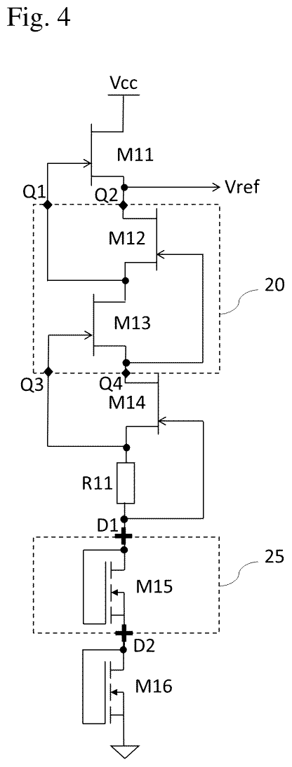

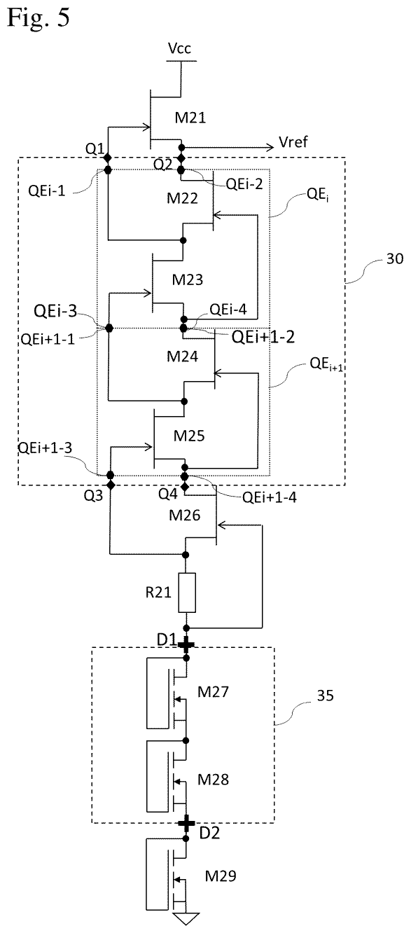

In the embodiment of FIG. 4, the connecting quadrupole 20 comprises two depletion-mode transistors M12, M13 in series: a top transistor M12 and a bottom transistor M13. The source of the top transistor M12 is connected to the drain of the bottom transistor M13 and to the first terminal Q1 of the connecting quadrupole 20. The first terminal Q1 is also connected to the gate of the leading transistor M11. The drain of the top transistor M12 is connected to the second terminal Q2 of the connecting quadrupole 20. The second terminal Q2 is also connected to the source of the leading transistor M11. The gate of the bottom transistor M13 being connected to the third terminal Q3 of the connecting quadrupole 20. The third terminal Q3 is also connected to the source of the trailing transistor M14. Finally, the gate of the top transistor M12 and the source of the bottom transistor M13 are connected to the fourth terminal Q4 of the connecting quadrupole 20, the latter also being connected to the drain of the trailing transistor M14. In the embodiment of FIG. 5, the connecting quadrupole 30 consists of two elementary quadrupoles QEi, QEi+1 connected in series, i.e. that the third terminal QEi−3 of the first elementary quadrupole QEi is connected to the first terminal QEi+1-1 of the second elementary quadrupole QEi+1 and the fourth terminal QEi−4 of the first elementary quadrupole QEi is connected to the second terminal QEi+1-2 of the second elementary quadrupole QEi+1. Each elementary quadrupole QEi, QEi+1 comprises two depletion-mode transistors M22-M26: a top transistor M22, M24 and a bottom transistor M23, M25. The source of each top transistor M22, M24 is connected to the drain of each bottom transistor M23, M25 and to a first terminal QEi−1, QEi+1-1 of each elementary quadrupole QEi, QEi+1. The drain of each top transistor M22, M24 is connected to a second terminal QEi−2, QEi+1-2 of each elementary quadrupole QEi, QEi+1, the gate of each bottom transistor M23, M25 is connected to a third terminal QEi−3, QEi+1-3 of each elementary quadrupole QEi, QEi+1 and the gate of each top transistor M22, M24 and the source of each bottom transistor M23, M25 are connected to a fourth terminal QEi−4, QEi+1-4 of each elementary quadrupole QEi, QEi+1. The terminals QEi−1 and QEi−2 respectively form the terminals Q1 and Q2 of the connecting quadrupole 30 and the terminals QEi+1-3 and QEi+1-4 respectively form the terminals Q3 and Q4 of the connecting quadrupole 30.

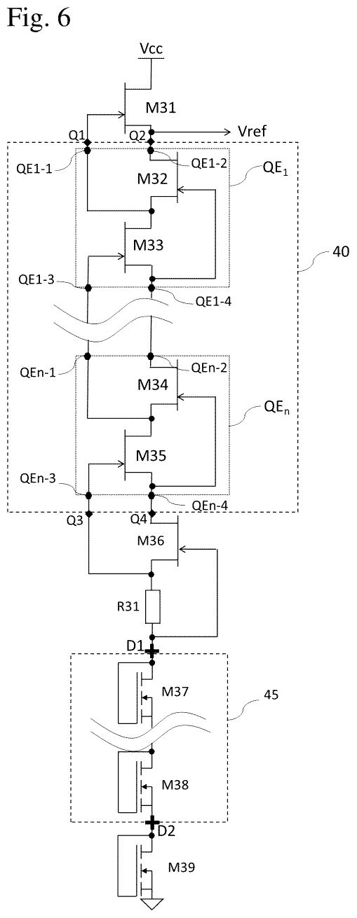

In the embodiment of FIG. 6, the connecting quadrupole 40 consists of n elementary quadrupoles QE1-QEn, with n>1. Each elementary quadrupole comprises two depletion-mode transistors: a top transistor M32, M34 and a bottom transistor M33, M35, connected in the same manner as for the elementary quadrupoles QEi, QEi+1 described in reference to FIG. 5. The elementary quadrupoles QE1-QEn are connected in series, with two consecutive elementary quadrupoles QEi, QEi+1 connected such that the first terminal QEi+1-1 of the elementary quadrupole QEi+1 is connected to the third terminal QEi−3 of the elementary quadrupole QEi and the second terminal QEi+1-2 of the elementary quadrupole QEi+1 is connected to the fourth terminal QEi−4 of the elementary quadrupole QEi. The first and the second terminal QE1-1, QE1-2 of the elementary quadrupole QE1 form the first and the second terminal Q1, Q2 of the connecting quadrupole 40 and the third and the fourth terminal QEn-3, QEn-4 of the elementary quadrupole QEn form the third and the fourth terminal Q3, Q4 of the connecting quadrupole 40.

The leading and trailing transistors are depletion-mode transistors. They can belong to the GaN transistor or MOS transistor category.

The trailing transistor M2, M14, M26, M36 is connected by its source to a terminal of a first dipole. The gate of the trailing transistor M2, M14, M26, M36 is connected to the second terminal of the first dipole. The first dipole can, for example, be a resistor R1, R11, R21, R31 such as illustrated in FIGS. 2 and 4-6, or also a diode. For example, the first dipole is an enhancement-mode transistor M4, mounted in a diode, i.e. that its gate is connected to its drain, such as illustrated in FIG. 3.

The second terminal of the first dipole is connected in series with a second dipole 15, 25, 35, 45.

In the embodiment of FIGS. 2 and 3, the second dipole 15 corresponds to a short-circuit.

In the embodiment of FIG. 4, the second dipole 25 comprises an enhancement-mode transistor M15, the source of which is connected to the second terminal of the second dipole 25, and the gate of which is connected to its drain. The latter is also connected to the first terminal of the second dipole 25.

In the embodiment of FIG. 5, the second dipole 35 comprises 2 enhancement-mode transistors M27, M28. Each transistor M27, M28 has its gate connected to its drain. The transistors M27, M28 are connected in series, i.e. that the source of the first transistor M27 is connected to the drain of the second transistor M28. The drain of the first transistor M27 thus forms the first terminal D1 of the second dipole 45 and the source of the second transistor M28 forms the second terminal D2 of the second dipole 45.

In the embodiment of FIG. 6, the second dipole 45 comprises n enhancement-mode transistors M37, M38. Each transistor M37, M38 has its gate connected to its drain. The transistors M37, M38 are connected in series, i.e. that two consecutive transistors M37, M38 are connected by the source of one and the drain of the other. The drain of the first transistor M37 thus forms the first terminal D1 of the second dipole 45 and the source of the last transistor M38 forms the second terminal D2 of the second dipole 45.

The second terminal of the second dipole 15, 25, 35, 45 is connected to a non-linear component. In practice, the non-linear component is a base transistor M3, M29, M39.

The base transistor M3, M29, M39 is advantageously an enhancement-mode transistor, the gate of which is connected to its drain. The base transistor M3, M29, M39 is connected to the ground by its source.

The voltage reference value Vref is measured at the source of the leading transistor M1, M11, M21, M31.

The upper part of the circuit, formed by the depletion-mode transistors M1, M2, M11-M14, M21-M26, M31-M36, taken individually is comprised as a current source when a current less than the saturation current passes through it. The voltage Vgs measured between the gate and the source of the depletion-mode transistors M1, M2, M11-M14, M21-M26, M31-M36 indeed extends to the voltage threshold value from which a channel is formed between the drain and the source of a given transistor. The voltage Vds measured between the drain and the source of the first depletion-mode transistor M1, M2, M11-M14, M21-M26, M31-M36 is therefore constant and the current delivered by the current source is substantially constant.

Given that the aim of the circuit is to obtain a voltage reference and not a current reference, this circuit is not sufficient by itself, and the voltage threshold value defined above can undergo a variation up to 50% according to the transistor manufacturing method.

The lower part of the circuit, formed by the enhancement-mode transistors M3, M15, M16, M27, M28, M29, M37, M38, M39 effectively supplies a voltage, but this is variable according to the current which passes through it.

Thus, by limiting the current delivered by the current source of the upper part of the circuit, it is possible to limit the voltage variations in the lower part of the circuit. It is therefore the association of the upper part and of the lower part of the circuit which makes it possible to obtain a substantially constant voltage reference.

Furthermore, the depletion-mode transistors have a negative threshold value, while the enhancement-mode transistors have a positive threshold value. In addition, the absolute value of the threshold value of an enhancement-mode transistor is equal to double the threshold value of a depletion-mode transistor. Thus, an enhancement-mode transistor makes it possible to compensate for a pair of depletion-mode transistors, when the lower part and the upper part of the circuit are combined. Due to this, it is advantageous that the transistors are N-channel gallium nitride (GaN)-based transistors, and that the number of depletion-mode transistors in the upper part of the circuit is equal to double the number of enhancement-mode transistors in the lower part of the circuit.

For example, in the circuit illustrated in FIG. 2, the role of the leading transistor M1 is to supply a voltage difference between the terminals connected to Vcc and to Vref such that the reference voltage Vref referenced at the ground is stable at the output of the circuit. This leading transistor M1 is, in particular, sized to supply a sufficient current level to a charge connected to the terminal Vref while the trailing M2 and base M3 transistors are sized to fix a polarisation current and a gate voltage necessary to control the leading transistor M1. In practice, to limit the effect of the current consumed by this charge on the value of the reference voltage Vref, a leading transistor M1 with an active surface larger than those of the trailing M2 and base M3 transistors will be chosen, in order to reduce the total electric consumption of the circuit.

The polarisation current which is fixed via the trailing transistor M2, is reduced and refined via the first dipole and, therefore, by the value of the resistor R1 in the case of FIG. 2. Indeed, with the polarisation current being less than the saturation current of the transistor M2, the voltage at the terminals of the resistor R1 (corresponding to the gate-source voltage of the transistor M2) is close to the threshold voltage of the depletion-mode transistor M2. The current is therefore determined by the threshold voltage of the depletion-mode transistor M2 and the resistor value of R1.

The value of the threshold voltage of the depletion-mode transistor M2 and the value of the resistor R1 will change under the effect of variations induced by the manufacturing process and/or temperature variations during operation, producing a variation of the polarisation current. The use of an integrated resistor R1 for the first dipole is however more advantageous with respect to the use of an enhancement-mode transistor which is even more sensitive to process variations. Thus, the resistor R1 makes it possible to reduce the impact of the variation due to the manufacturing process on the reference voltage Vref at the output of the circuit of a ratio close to 10.

The base transistor M3 is configured to offset the output voltage and compensate for the changes due to the process and/or temperature variations of the depletion-mode transistors M1 and M2. In practice, this transistor M3 must be sufficiently large to compensate for these changes, without making the process variations more sensitive.

The voltage reference circuit obtained is therefore not very sensitive to fluctuations in supply voltage, temperature and transistor manufacturing method variations. Another advantageous feature of the circuit of the invention is that it consumes little energy, typically around 3 μA to 10 μA.

Finally, the voltage reference circuit can manage charges up to 10V with a variation of only 6% of voltage.

Measurements have been taken by the Applicant, in order to compare the performances obtained between the circuit of the invention and a circuit of the state of the art.

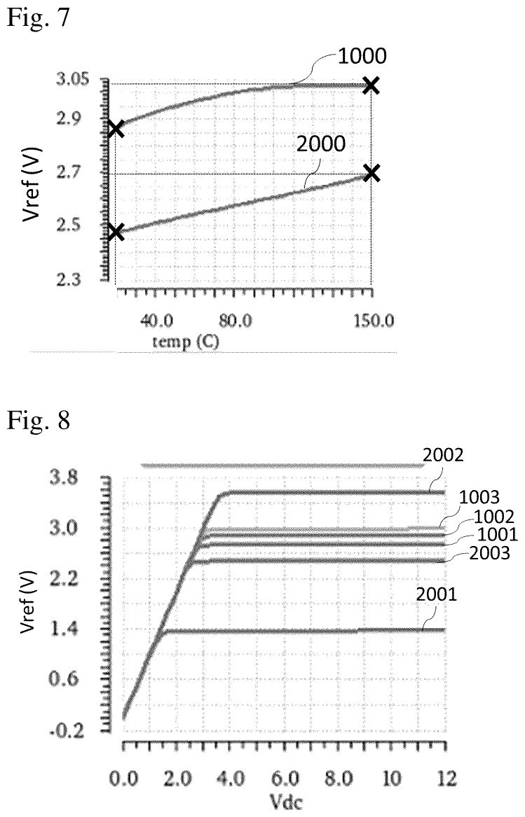

Such as illustrated in FIG. 7, for the circuit of the invention 1000, when the temperature varies between +20° C. and +150° C., it is observed that the reference voltage Vref varies between 2.86 and 3.02V, that is a variation of 0.16V.

For the circuit of the state of the art 2000, when the temperature varies between +20° C. and +150° C., it is observed that the reference voltage Vref varies between 2.47 and 2.7V, that is a variation of 0.23V, that is 50% more than the circuit of the invention.

Thus, the invention effectively makes it possible to limit the variations of reference voltage Vref according to the temperature, compared with circuits of the state of the art. Likewise, FIG. 8 compares the variations of reference voltage Vref for theoretically identical transistors, but the intrinsic parameters of which differ due to manufacturing tolerances. For the circuit of the state of the art 2001, 2002, 2003, it is noted that for a supply voltage greater than 4V, the reference voltage Vref measured for the transistors 2001 and 2003 varies from 1.4 to 3.6V, that is about 44% of variation from one transistor to the other. For the circuit of the invention 1001, 1002, 1003, the reference voltage Vref varies between 2.8 and 3V, that is about 7% of variation from one transistor to the other, i.e. six times less than for the circuit of the state of the art.

Thus, the invention effectively makes it possible to limit the variations of the reference voltage Vref according to the tolerances of the transistor manufacturing methods.

1. Voltage reference circuit comprising:
a leading depletion-mode transistor, a drain of which is connected to a voltage source,
a trailing depletion-mode transistor, a source of which is connected to a terminal of a first dipole, and a gate of which is connected to a second terminal of the first dipole,
a connecting quadrupole, the first terminal of which is connected to the gate of the leading transistor, the second terminal of which is connected to the source of the leading transistor, a third terminal of which is connected to the source of the trailing transistor and a fourth terminal of which is connected to the drain of the trailing transistor, the reference voltage being supplied to the source of the leading transistor, and
a base enhancement-mode transistor, the source of which is connected to a ground, and the gate of which is connected to its drain, said drain being connected to a second terminal of a second dipole, the first terminal of which is connected to the second terminal of the first dipole.

2. Voltage reference circuit according to claim 1, characterised in that the connecting quadrupole consists of two short-circuits respectively connecting the first and third terminals and the second and fourth terminals.

3. Voltage reference circuit according to claim 1, characterised in that the connecting quadrupole comprises two depletion-mode transistors: a top transistor and a bottom transistor, the source of the top transistor being connected to the drain of the bottom transistor and to the first terminal of the connecting quadrupole, the drain of the top transistor being connected to the second terminal of the connecting quadrupole, the gate of the bottom transistor being connected to the third terminal of the connecting quadrupole and the gate of the top transistor and the source of the bottom transistor being connected to the fourth terminal of the connecting quadrupole.

4. Voltage reference circuit according to claim 1, characterised in that the connecting quadrupole consists of n elementary quadrupoles, with n>1, each elementary quadrupole comprising two depletion-mode transistors: a top transistor and a bottom transistor, the source of the top transistor being connected to the drain of the bottom transistor and to a first terminal of the elementary quadrupole, the drain of the top transistor being connected to a second terminal of the elementary quadrupole, the gate of the bottom transistor being connected to a third terminal of the elementary quadrupole and the gate of the top transistor and the source of the bottom transistor being connected to a fourth terminal of the elementary quadrupole; the elementary quadrupoles being connected in series, with two consecutive elementary quadrupoles connected such that the first terminal of the elementary quadrupole is connected to the third terminal of the elementary quadrupole and the second terminal of the elementary quadrupole is connected to the fourth terminal of the elementary quadrupole; and the first and the second terminal of the elementary quadrupole forming the first and the second terminal of the connecting quadrupole and the third and the fourth terminal of the elementary quadrupole forming the third and the fourth terminal.

5. Voltage reference circuit according to claim 1, characterised in that the depletion-mode and enhancement-mode transistors are GaN transistors or MOS transistors.

6. Voltage reference circuit according to claim 1, characterised in that the first dipole is a resistor.

7. Voltage reference circuit according to claim 1, characterised in that the first dipole is an enhancement-mode transistor, the gate of which is connected to its drain.

8. Voltage reference circuit according to claim 2, characterised in that the second dipole is a short-circuit.

9. Voltage reference circuit according to claim 3, characterised in that the second dipole comprises an enhancement-mode transistor, the source of which is connected to the second terminal of the second dipole and the gate of which is connected to its drain, said drain being connected to the first terminal of the second dipole.

10. Voltage reference circuit according to claim 4, characterised in that the second dipole comprises n enhancement-mode transistors, each of said transistors having its gate connected to its drain, said transistors being connected in series, two consecutive transistors being connected by the source of one and the drain of the other and, the drain of the first transistor forming the first terminal of the second dipole and the source of the last transistor forming the second terminal of the second dipole.
